(19) United States
(12) Patent Application Publication
(10) Pub. No.: US 2009/0043623 A1
(43) Pub. Date: Feb. 12, 2009

(54) Method and system for effective market research

(75) Inventors: Fiona Jane Blades, London (GB); Stephen Peter Phillips, London (GB)

Correspondence Address: IP GROUP OF DLA PIPER US LLP, ONE LIBERTY PLACE, 1650 MARKET ST, SUITE 4900, PHILADELPHIA, PA, 19103, US

(73) Assignee: MESH Planning Tools Ltd., London (GB)

(21) Appl. No.: 11/890,586

(22) Filed: Aug. 7, 2007

(51) Int. Cl. G06F 9/44

(52) U.S. Cl. 705/7

(57) ABSTRACT

A method of improving market research to understand the effectiveness of advertising campaigns is provided. A first questionnaire is provided to one or more survey participants that includes questions relating to participant's prior interactions with and beliefs about one or more advertised brands. For a predetermined time, the participants then go about their normal every day activities and simultaneously, while experiencing an advertisement or a brand, they provide, to a survey administrator, communications related to the brand via a mobile telecommunication device. These communications are compiled and displayed. During the predetermined time, an administrator may recommend real-time adjustments to the advertising campaign based on data collected via the communications. Shortly after the predetermined time ends, a second questionnaire is provided, which relates to the participant's interactions during their normal daily activities. The questionnaire responses are compared and along with the information provided in the communications, a determination is made regarding the effectiveness of the advertising that the participants encountered.

### FIELD OF THE INVENTION

The present invention relates generally to methods and systems for determining consumer perception of certain brands in the market. In particular, it is a method and system for determining the effectiveness of advertising.

### BACKGROUND

Most current methods for determining an advertising campaign's effectiveness on consumers focus only on “large media” advertising; most notably, television. Viewers (or potential viewers) are interviewed and/or surveyed and asked which advertisements they recall viewing on television in the recent past. The results of the interviews/surveys are then cumulated and analyzed. The frequency with which a particular advertisement is recalled is used to estimate the viewing public's “awareness” of that advertisement. Conventional thinking provides that the more “aware” the public is, the more “effective” the particular marketing campaign is considered to be.

These methods are flawed. Because they examine only large media advertisement-awareness such as TV or radio, they fail to account for other important media such as events, promotions, online, etc. Also, most methods ask consumers to recall advertisements long after they have seen them and as a result, many consumers “over claim,” which means they will say that they have recently seen advertisements that have not been broadcast via television or radio for quite some time. Consumers will most often over claim with respect to advertisements relating to heavily-advertised and well-recognized brands, such as Coke®, for example.

To overcome this problem of over claiming, methods have been developed that include a “baseline” of over claimed awareness. Using regression modeling, these methods determine what percentage of claimed awareness is “over claim,” and then uses the over claim percentage as a baseline. Thus, for instance, if television awareness of Coke advertising was determined to be 60%, the ‘baseline’ approach would recognize that “over claim” in determining the “true” awareness of the Coke advertising. But even if the baseline approach helps in identifying awareness of truly recent advertisements, many people still tend to identify the incorrect media in which they saw a particular advertisement. Specifically, many people will say that they saw a particular advertisement on large media (e.g., television), even if they did not in fact see it on television because, for example, it ran in print only.

Methods, including the “IPA Touchpoints” method and the “Project Apollo” method, have been developed in an attempt to overcome the above problems by collecting information from consumers in “real-time.” “Real-time” means that they attempt to collect feedback from the consumer as he or she is experiencing an advertisement, product, or brand.

The IPA Touchpoints' method provides consumer-survey participants with Personal Digital Assistants (PDAs). During their “normal” day, consumers are asked to report, via their respective PDA, which media they were tuned into (if any) every half-hour. To illustrate, if at 2:30 pm a participant were listening to the radio, that participant would report, via his PDA, his location, the activity he was engaged in, and that he was listening to the radio at 2:30 pm. Thirty minutes later, at 3:00 pm, the participant would report his location and activities at that time. This reporting would continue every thirty minutes for a predetermined period of time. After a week-long data collection period, IPA compiles the data and attempts to draw inferences related to the media consumption of several classes of participants. This method may be effective in determining which media certain classes of consumers engage in during their day, and therefore, which media channels companies should focus on. However, it does not provide information regarding which advertisements or brands consumers encounter, how often they encounter them or how consumers feel about the advertisements and brands they encounter. Further, this method is an industry research initiative and therefore, is not tailored for use by a particular entity that wants to measure the effectiveness of its own and/or a competitor's advertisements.

The Project Apollo's method collects real-time consumer information via “Portable People Meters” (PPMs). According to this method, a company hands out PPMs to selected respondents who keep them only for a set period of time. The PPMs are used to sense and capture data signals that are encrypted into advertisements, such as television advertisements and posters. As a PPM carrier enters the vicinity of an advertisement, the PPM will sense and capture the encrypted data signal emanating therefrom. These data signals can in turn be used to determine how many participants were in the vicinity of a particular media channel at the time an advertisement was broadcast. Furthermore, Project Apollo is passive and accepts no input from participants. All that is required (to capture data) is that a participant (carrying a PPM) be in the vicinity of a broadcast data signal. If the participant is asleep, engaged in a demanding activity, or otherwise preoccupied, and not actually perceiving the advertisement, the PPM will nonetheless capture the broadcast data signal. As can be appreciated, this may lead to over-stating (similar to overclaiming described above) the reach and effectiveness of particular advertisements. No qualitative data, (e.g., whether the advertisement was actually perceived, how the advertisement made the participant feel, etc.), is captured.

### SUMMARY OF THE INVENTION

The various embodiments of the invention disclose a system and method of market research designed to determine the effectiveness of advertisements or a marketing campaign. The system and method provide quantitative and qualitative data related to particular advertising campaigns in particular media channels in real-time so as to enable disseminators of the advertising campaigns to observe and/or refine such campaigns in real-time.

In one embodiment, the invention is a method of improving market research to understand the effectiveness of an integrated advertising campaign, the method comprising: providing a first questionnaire to one or more participants that includes one or more questions relating to past participant interactions with and beliefs about one or more advertised brands, for a predetermined period of time after providing the first questionnaire, the one or more participants generating and transmitting, in real-time, a communication from a participant's-own mobile telecommunication device to a server computer each time the one or more participants experiences a current participant interaction with the one or more advertised brands, the communication comprising real-time quantitative tracking data; at the server, compiling and displaying the quantitative tracking data in real-time; after the predetermined period of time, providing a second questionnaire to the one or more participants comprising one or more questions relating to the current participant interactions; compiling the qualitative and quantitative tracking data, and results from the first and second questionnaires to determine an advertising effectiveness of the one or more brands; and recommending adjustments to the integrated advertising campaign based on the determined advertising effectiveness.

In another embodiment, the invention is a computer system comprising: at least one server computer; and, at least one participant mobile telecommunication device coupled to the at least one server computer, the participant mobile telecommunication device comprising at least one computer program configured to receive input from a participant, the input including information relating to at least one questionnaire provided by the server computer and at least one participant's interaction with one or more advertised brands, the computer program configured to generate at least one communication relating to the input, wherein the communication comprises real-time quantitative tracking data; wherein the at least one server computer comprises at least one computer program being capable of performing the steps of: providing to the participant mobile telecommunication device, a first questionnaire that includes one or more questions relating to past participant interactions with and beliefs about one or more advertised brands; accepting the at least one communication from the participant mobile telecommunication device; storing the at least one communication from the participant mobile telecommunication device; compiling and displaying the quantitative tracking data in real-time; providing to the participant mobile telecommunication device, a second questionnaire that includes one or more questions relating to the participant's interaction with one or more advertised brands; compiling the qualitative and quantitative tracking data, and the at least one communication from the participant mobile telecommunication device to determine an advertising effectiveness of one or more advertised brands.

### BRIEF DESCRIPTION OF THE DRAWINGS

For the purpose of illustrating the invention, the drawings show forms of the invention that are presently preferred. However, it should be understood that this invention is not limited to the precise arrangements and instrumentalities shown in the drawings.

FIG. 1 is a diagram illustrating an exemplary embodiment of a method of market research to understand the effectiveness of an integrated advertising campaign.

FIG. 2 is plan view showing a computer system for carrying out the method of FIG. 1 according to an embodiment of the present invention.

### DETAILED DESCRIPTION OF THE INVENTION

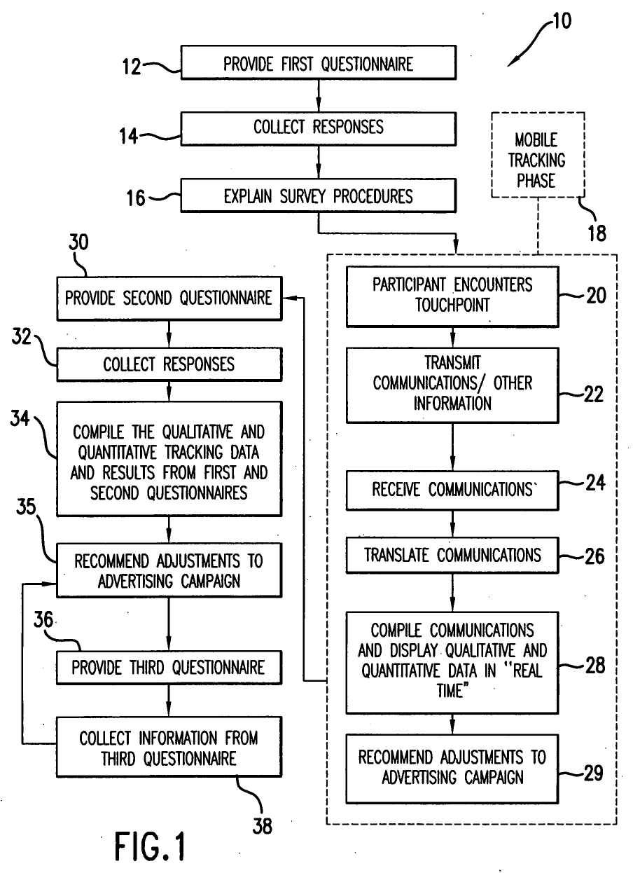

FIG. 1 shows an embodiment of a method of market research to understand the effectiveness of an integrated advertising campaign 10 according to the present invention. A first questionnaire is provided by survey administrators, to a group of consumer participants or respondents (step 12). Survey administrators may be any persons or organizations implementing the method including private or public agencies. Preferably, the first questionnaire is similar to the “awareness” type questionnaires currently used on the market and explained above. The first questionnaire may include screening questions and questions for collecting information from survey participants regarding brand health, image, usage, behavior and advertising awareness. For example, the questionnaire may ask about which advertisement(s) the participants have recently seen, when they saw the advertisement(s), what media the advertisement(s) were in and which brand(s) the advertisement(s) were for. The questionnaire may be provided to the participants via any means known in the art. This may include paper, in-person, via mail, by telephone, or electronically (via email, a website, etc. as explained below).

Once each participant completes the first questionnaire, the questionnaires are returned to the administrator who collects the responses (step 14). The first questionnaires may be returned or sent to the administrator via any of the means discussed above. In one embodiment discussed below, participants return the first questionnaires to the administrator electronically (e.g., via email) over a network.

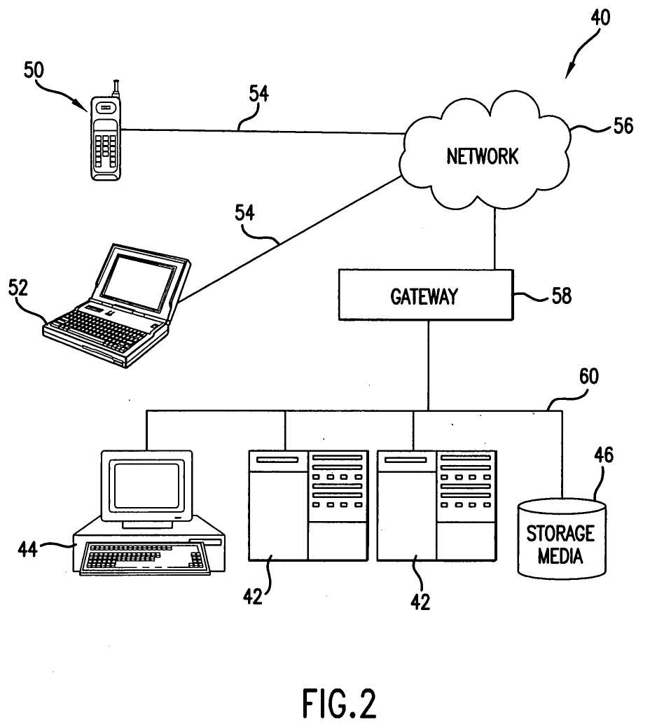

Next, the administrators explain the next steps of the survey procedures to the participants (step 16). This may include a meeting, which may occur by any means known in the art such as face-to-face, telephone, internet, etc., or simply providing instructions to the participants via a text or voicemail message. During this explanation step, each participant has to have a participant mobile telecommunication device, examples of which are shown in FIG. 2 and explained in detail below. The mobile telecommunication device may be any device that has means for communicating with the administrator such as a cellular telephone 50, however, it may be a PDA (not shown), wireless data transmitter (not shown), etc. Participants may also utilize participant computers, in addition to mobile telecommunication devices, to communicate with the administrator. Optionally, the participants may provide their cellular telephone numbers to the administrator who stores the telephone numbers in a survey database (not shown). The numbers may then be passed from the survey database (within a server computer 42, shown in FIG. 2) through to an SMS facilitator (not shown), which generates a text message on the participants' mobile telecommunication device 50 with instructions and codes for the “mobile tracking” phase, which is explained below. Because each participant uses their own mobile telecommunication device, the process of finding and briefing participants to take part in such a study is made significantly easier than would otherwise be the case.

After the explanation step (step 16), the participants go about their “normal” day, carrying their mobile telecommunication device wherever they go. This stage may be referred to as “mobile tracking” (step 18). As participants go shopping, to the movies, drive, watch television, listen to the radio, read, etc., whenever they encounter an advertising “touchpoint” (step 20) such as a billboard, television or radio commercial, etc., they send a communication from their mobile telecommunication device to a server computer (step 22) that is preferably maintained by the administrator. A “touchpoint” includes virtually any encounter with a product, not just an advertisement (e.g., word-of-mouth or simply seeing a product in a store or a home). An “encounter” may include viewing, hearing, smelling, touching, tasting, using, and purchasing a product associated with one or more of the advertised brands at a specific touchpoint. It is noted that the participants may encounter roughly twelve to fifteen different advertising touchpoints relevant to the brands being surveyed during a normal week, although this number may vary. Since the participants send the communication regardless of the media in which they encounter the advertisement, the present method does more than just monitor the effectiveness of television advertisements.

The communication generated and sent by the participants may be any communication that their respective mobile telecommunication device is capable of sending, for example, a text message, a voice or telephone message, an email message, etc. If the communication is a text message, the text message may be in any form known in the art, for example, a Short Message Service (SMS) text message. The communications sent by the participants include “real-time” quantitative tracking data such as the date and time that the communication was sent.

The data provided in the communications is preferably provided in a “short-hand” format, such as via codes. In one embodiment, each communication may comprise three codes, one each for communicating the brand advertised (e.g., Coke®), the media or type of encounter (i.e., print, television, radio, conversation overheard about a brand, seeing in store, using the brand etc.) in which the brand was advertised or encountered, and how the participant felt about the encounter or advertisement. How the participant “felt about the encounter or advertisement” may be indicative of whether the encounter increased the consumer's favorability of the brand, whether it made him or her more likely to purchase the particular product or other products from the brand, etc.

In another embodiment, participant communications may comprise letters and numbers, wherein letters are assigned to certain brands and media, and numbers are assigned to the participant's reaction to the advertisement (e.g., his or her feeling about the product). For example, a participant who is experiencing a television advertisement for a Coke® product may send a communication that reads “B” (the letter corresponding to Coke®), “D” (the letter corresponding to television) and “4”, an “effectiveness indicator”, which communicates how the participant's felt about the product based upon the encounter on a scale from one through five, with five being the best rating. In addition, the participant may be able to include, in their communications, photos, video footage, etc. of their experiences with the advertisements or encounters. This allows for a greater understanding of how products and brands are viewed by the participants in real time.

The participants' communications are received by the administrators (via the server computer) (step 24). These communications may be received over a wireless network via a network server computer that is monitored by the administrator, as shown in FIG. 2. Participants' data and feedback is then translated (step 26) (if necessary) by either a gateway or a computer program within the server computer(s) (FIG. 2) so that the information appears as a readable message and not short-hand codes. At the server computer(s), the communications are compiled and displayed in real-time (step 28).

It should be noted that in addition to “coded” participant communications, each participant may (and is encouraged to) provide supplemental information (e.g., photos, video footage, narratives, etc.) regarding their respective encounters. This supplemental information may be provided via their mobile telecommunication devices, or alternatively, via a computer. All of the participants' communications, regardless of type, are entered into a virtual “diary”. This virtual diary is a data storage location accessible via a website, such as via www.MySMSDiary.co.uk, for example. Preferably, the virtual diary is configured to ask qualitative questions of the participants during the predetermined time period, and allows participants to view and comment on their previously submitted communications within the virtual diary. As noted above, this is also where participants can upload photos or video related to their interactions, as previously described.

An example of a qualitative question posed by this virtual diary includes: “Which were the participants' least and most positive experiences?” Another question may inquire as to whether any favorable advertisements were linked to any other advertisements. These inquiries enables the administrator to track advertisements that lead to a purchase or packaging that generates word-of-mouth, and to provide real-time recommendations for modifying the advertising campaign. Thus, as participant communications (and answers to qualitative questions) are received (step 24) and compiled (step 28), the administrator analyzes the compiled data and recommends real-time adjustments for improving the advertising campaign (step 29). The advantage of this immediate feedback processing and analysis is that advertising campaigns can be refined as they progress.

In sum, during the mobile tracking phase, participants provide real-time data/feedback regarding advertisements that they encounter during their normal day. Based on this feedback, the administrator can make recommendations about modifying the integrated advertising campaign in real-time during the predetermined period. The participants may perform the mobile tracking phase for any pre-determined period of time but typically, it will be one week or more.

Next, a second questionnaire is provided to the participants (step 30). The second questionnaire may be in any format as provided above with respect to the first questionnaire. Preferably, this second questionnaire is submitted immediately after the mobile tracking phase ends. The second questionnaire may ask some or all of the same questions in the first questionnaire.

After the second questionnaire is completed (step 30), the administrator collects the responses (step 32) and then compares the responses from the first questionnaire to the responses to the second questionnaire and compiles the qualitative and quantitative tracking data (step 34) from the mobile tracking phase (step 18). This indicates the direction which the brand is heading versus its competitors and allows the administrator to determine an advertising return-on-investment (ROI). The administrator then recommends adjustments to the advertising campaign (step 35).

Optionally, the administrator provides a third questionnaire (step 36) to the participants. This third questionnaire is, in effect, a follow-up survey which allows respondents to interact with other participants over a period of 1-4 weeks following their completion of the second questionnaire. In one embodiment, this third questionnaire is an open “chat room” for survey participants. For example, participants may be able to go into their own online forum, preferably a virtual “boardroom.” Here, participants are invited to join other participants in the project to discuss their views in more detail, comment on each others' experiences and vote on brands, advertisements, etc. Participants can also make suggestions regarding the research method. Companies, planners, advertising executives, and creative personnel can post questions for or “chat” with the participants to engage directly with these participants to gather further insight into their advertisements. The information from the third questionnaire is collected (step 38) and may be compiled and analyzed in a similar manner as described above with respect to the first and second questionnaires.

The results of the above method allow the administrator to determine the effectiveness of advertising. Effectiveness may be measured by brand health, brand image, brand usage, brand behavior. The present system and method also measures effectiveness by determining the “Awareness Index”, “Touchpoint Ratings” (i.e., percentage of total market ratings achieved by brand or touchpoint), “Reach” (i.e., penetration of touchpoints relative to competitors), “Frequency” (i.e., the number of times participants are interacting with the brand or touchpoint), and “Cost Per Touchpoint” (i.e., the money spent to achieve the touchpoints for different channels). Optionally, the administrator provides the results of the findings in a report (step not shown).

As provided above, the method of the present invention may be implemented via a computer system, one embodiment of which is shown as element 40 in FIG. 2. In the preferred embodiment, the system 40 comprises at least one server computer 42 coupled to at least one display computer 44 and at least one storage media 46. These components comprise a Local Area Network (LAN) or Wide Area Network (WAN) 60. At least one participant mobile telecommunication device 50, e.g. mobile telephone, is coupled to the at least one server computer 42. In addition, a participant computer 52 may also be coupled to the server computer 42. The participant mobile telecommunication device 50 (and optional computer 52) comprise at least one computer program (not shown) configured to receive input from a participant regarding his or her interaction with one or more advertised brands, answers to the questionnaires, etc. The input into the participant mobile telecommunication device/computer 50, 52 may be text, voice, etc. These participant devices 50 52 are capable of generating communications 54 relating to the input. Preferably, the participant mobile telecommunication device/computer 50,52 sends the communications 54 to the server computer 42 via a wireless network 56. However, the participant devices 50, 52 may communicate with the server computer(s) 42 via any means known in the art such as via a hard wired connection. The wireless network 56 may include a gateway 58 coupled to the server computers, storage media, display computer and network, for facilitating access to the LAN 60. The storage media may be configured as a database from which information can be uploaded and downloaded.

The server computer(s) includes at least one computer program stored thereon (not shown). This program is capable of providing to the participant device(s) 50, 52 (via the network 56), questionnaires and instructions; storing responses to the questionnaires, participants' photos, videos, etc. (in the storage media 46); accepting communications 54 from the participant device(s) 50, 52 during the mobile tracking phase; compiling and displaying the quantitative tracking data within the communications in real-time (on the display computer 44); and compiling and comparing the qualitative and quantitative tracking data, and responses from the questionnaires. The server computer(s) program is also capable of providing a virtual board or “chat” room as described above. In another embodiment, a printer (not shown) is coupled to the server computers 42 or display computer 44.

The present method and system provide many advantages over the prior art in addition to those already discussed. Real-time tracking allows the administrator to see how people react to a product at a particular time and how that affects their overall view of the product. For example, an advertisement for food when participants are hungry will likely have a more significant impact than when they are not hungry. As another example, people tend to favor healthier foods at the beginning of the week and less health foods at the end of the week.

Further, the photographs or video that participants provide show the advertisements as they actually appear in the real world, in a home, or in a store; which in turn enables the administrator to see how consumers perceive advertisements in a particular context. In addition, comparing participants' answers in the first questionnaire versus their answers in the second questionnaire provides the administrator with an idea of where the particular brand or product is heading.

Although the invention has been described and illustrated with respect to the exemplary embodiments thereof, it should be understood by those skilled in the art that the foregoing and various other changes, omissions and additions may be made therein and thereto, without parting the spirit and scope of the present invention.

What is claimed is:

1. A method of improving market research to understand the effectiveness of an integrated advertising campaign, the method comprising:
providing a first questionnaire to one or more participants that includes one or more questions relating to past participant interactions with and beliefs about one or more advertised brands;
for a predetermined period of time after providing the first questionnaire, the one or more participants generating and transmitting, in real-time, a communication from a participant mobile telecommunication device to a server computer each time the one or more participants experiences a current participant interaction with the one or more advertised brands, the communication comprising real-time quantitative and qualitative tracking data;
at the server computer, compiling and displaying the quantitative and qualitative tracking data in real-time;
after the predetermined period of time, providing a second questionnaire to the one or more participants comprising one or more questions relating to the current participant interactions;
compiling the qualitative and quantitative tracking data, and results from the first and second questionnaires to determine an advertising effectiveness of the one or more brands; and
recommending adjustments to the integrated advertising campaign based on the determined advertising effectiveness.

2. The method of claim 1, further comprising:
during the predetermined period of time, the server computer generating one or more qualitative questions relating to the current participant interactions and providing said qualitative questions to the one or more participants;
the one or more participants generating and transmitting responses to the qualitative questions;
the server computer compiling the responses to the qualitative questions together with the qualitative and quantitative tracking data; and
recommending real-time adjustments to the integrated advertising campaign before the predetermined period of time terminates.

3. The method of claim 1, wherein at least one of the first and second questionnaires are provided via one of face-to-face, telephone, and online over the Internet.

4. The method of claim 1, wherein the first questionnaire comprises one or more screening questions and one or more questions relating to brand awareness, brand usage, advertising awareness, brand image, and brand favorability.

5. The method of claim 1, wherein the communication comprises a code indicative of a brand, a brand touchpoint, a type of interaction, and an effectiveness indicator.

6. The method of claim 5, wherein the communication includes a time and date stamp.

7. The method of claim 5, wherein the communication comprises a text message.

8. The method of claim 5, wherein the participant mobile telecommunication device is at least one of a cellular telephone, a personal digital assistant, and a wireless data transmitter.

9. The method of claim 8, wherein a current participant interaction includes at least one of viewing, hearing, smelling, touching, tasting, using, and purchasing a product associated with one or more of the advertised brands at a specific touchpoint.

10. The method of claim 9, wherein the specific touchpoint comprises at least one of a media channel, a word-of-mouth interaction, and an experiential interaction.

11. The method of claim 1, wherein the second questionnaire comprises qualitative questions relating to participant interactions reported during the predetermined period.

12. The method of claim 1, wherein determining advertising effectiveness comprises determining at least one of brand health, brand image, brand usage, brand behavior, and advertising awareness.

13. The method of claim 12, wherein determining advertising effectiveness further comprises determining a touchpoint rating comprising a percentage of total market ratings achieved by the one or more advertised brands in one or more touchpoints.

14. The method of claim 12, wherein determining advertising effectiveness further comprises determining a brand reach of the one or more brands, said brand reach comprising a measure of relative brand penetration in certain touchpoints.

15. The method of claim 12, wherein determining advertising effectiveness further comprises determining an interaction frequency, said interaction frequency being a measure of the frequency with which a participant interacts with a brand or touchpoint.

16. The method of claim 12, wherein determining advertising effectiveness further comprises determining a cost associated with reaching one or more touchpoints.

17. The method of claim 1, further comprising comparing results from the second questionnaire results with results from the first questionnaire and determining an advertising return-on-investment (ROI) based on the comparison.

18. The method of claim 1, further comprising making recommendations about modifying the integrated advertising campaign in real-time during the predetermined period in response to the displayed qualitative and quantitative tracking data.

19. The method of claim 1, further comprising the one or more participants periodically providing comments and additional data to the server computer for use in determining the advertising effectiveness of the one or more brands.

20. The method of claim 19, wherein the additional data comprises at least one of video data, photographs, and audio data.

21. The method of claim 1, further comprising administering a follow-on group survey with the one or more participants.

22. The method of claim 21, wherein the follow-on group survey is administered as an online group discussion.

23. A computer system comprising:
at least one server computer; and,
at least one participant mobile telecommunication device coupled to the at least one server computer, the participant mobile telecommunication device being configured to receive input from a participant, the input including information relating to at least one questionnaire provided by the server computer and at least one participant's interaction with one or more advertised brands, the mobile telecommunication device being further configured to generate at least one communication relating to the input, wherein the communication comprises real-time qualitative and quantitative tracking data;
wherein the at least one server computer comprises at least one computer program being capable of performing the steps of:
providing to the participant mobile telecommunication device, a first questionnaire that includes one or more questions relating to past participant interactions with and beliefs about one or more advertised brands;
accepting the at least one communication from the participant mobile telecommunication device;
storing the at least one communication from the participant mobile telecommunication device;
compiling and displaying the qualitative and quantitative tracking data in real-time;
providing to the participant mobile telecommunication device, a second questionnaire that includes one or more questions relating to the participant's interaction with one or more advertised brands, and
compiling the qualitative and quantitative tracking data, and the at least one communication from the participant mobile telecommunication device to determine an advertising effectiveness of one or more advertised brands.

24. The system of claim 23, wherein the server computer program is configured to:
generate and transmit one or more qualitative questions relating to the participant's interaction with the one or more advertised brands; and
compile responses to the qualitative questions, together with the qualitative and quantitative tracking data, to determine an advertising effectiveness of the one or more advertised brands.

25. The system of claim 23, wherein the at least one participant mobile telecommunication device is coupled to the at least one server computer through a network.

26. The system of claim 23, wherein the participant mobile communication device is a cellular telephone, which has SMS capabilities.

27. The system of claim 23, wherein the server computer program is capable of performing the step of providing a third questionnaire and storing and compiling at least one communication relating to the third questionnaire, wherein the third questionnaire comprises an online group discussion.

28. The system of claim 23, wherein the server computer program is capable of performing the step of generating a report based on the determined advertising effectiveness.

29. The system of claim 23, wherein the server computer program is capable of performing the step of translating codes within the messages to a readable text.

30. The system of claim 23, further comprising a participant computer coupled to the at least one server, said participant computer being configured to receive input from the participant, to generate one or more communications relating to the input, and to transmit the communications to the computer server.
